(19) United States
(12) Patent Application Publication
(10) Pub. No.: US 2007/0036310 A1
(43) Pub. Date: Feb. 15, 2007

(54) Members calling card

(75) Inventors: Jeffrey B. Smith, Veradale, WA (US); Michael L. Eberle, Vista, CA (US)

Correspondence Address: LEE & HAYES, PLLC, 421 W. RIVERSIDE AVE, STE 500, SPOKANE, WA, 99201, US

(73) Assignee: dX/dY Voice Processing, Inc., Spokane, WA (US)

(21) Appl. No.: 11/188,345

(22) Filed: Jul. 25, 2005

(51) Int. Cl. H04M 15/00

(52) U.S. Cl. 379/114.15

(57) ABSTRACT

Members calling card is described. In an embodiment, a call source initiates communication with a call-in service that then provides contact information via which the call source can obtain a members calling card to access, or continue accessing, the call-in service. A switch receives a communication from the call source that initiates use of the contact information and the switch establishes a communication link between the call source and a card provider such that the call source can obtain the members calling card. The members calling card is issued such that communication with the call-in service is charged on a telephone bill associated with the call source. The switch establishes a telephone-based communication link to enable communication between the call source and the call-in service where the communication is charged to the telephone bill associated with the call source.

### TECHNICAL FIELD

This invention relates to calling cards.

### BACKGROUND

Some call-in services, such as a call-in information service, technical service, or other paid access call-in service, require a caller to pay a fee to access the service, typically on a per-minute basis. The billing rate can be paid for by a caller with a credit card (e.g., Visa, Master Card, or American Express). Some potential customers may not have access to a credit card, or have a credit card with enough remaining credit or a high enough limit, to pay for the per-minute billing rate access fee. These potential customers, as well as the providers of call-in services, would benefit from an alternate payment system via which a caller can pay for access to the call-in services.

### SUMMARY

Members Calling Card is described herein.

In an implementation, a call source initiates communication with a call-in service that then provides contact information via which the call source can obtain a members calling card to access, or continue accessing, the call-in service. A switch receives a communication from the call source that initiates use of the contact information and the switch establishes a communication link between the call source and a card provider such that the call source can obtain the members calling card. The members calling card is issued such that communication with the call-in service is charged on a telephone bill associated with the call source. The switch establishes a telephone-based communication link to enable communication between the call source and the call-in service where the communication is charged to the telephone bill associated with the call source.

### BRIEF DESCRIPTION OF THE DRAWINGS

The same numbers are used throughout the drawings to reference like features and components.

FIG. 1 illustrates an exemplary members calling card system.

FIG. 2 illustrates another exemplary members calling card system.

FIG. 3 illustrates examples of data associated with members calling card which is maintained with a database as shown in FIG. 2.

FIG. 4 illustrates examples of recorded and associated data maintained with an archive as shown in FIG. 2.

FIG. 5 illustrates an exemplary members calling card system having any number of various components.

FIG. 6 illustrates an exemplary implementation of members calling card.

FIG. 7 further illustrates the exemplary implementation of members calling card as shown in FIG. 6.

FIG. 8 illustrates a diagram of an exemplary method for members calling card.

FIG. 9 illustrates another diagram of an exemplary method for members calling card.

FIG. 10 illustrates various components of an exemplary computing device that may be implemented as various components of a members calling card system.

### DETAILED DESCRIPTION

Members Calling Card is described in which a call source, such as a caller, can initiate communication with a call-in service, such as an automated dating service. The call-in service provides contact information to the call source via which the call source can obtain a members calling card to access, or continue accessing, the call-in service. A switch receives a communication (e.g., a telephone call) from the call source that initiates use of the contact information received from the call-in service. The switch then establishes a communication link between the call source and a card provider such that the call source can obtain the members calling card. The members calling card is issued such that communication with the call-in service is charged on a telephone bill associated with the call source.

The card provider can be a live person (e.g., an operator), an automated device, or any other type of telecommunication device that issues the members calling card to the call source which can then gain access to the call-in service. The card provider issues the members calling card to the call source when the card provider receives authorization from the call source that a billing rate for access to the call-in service can be billed on the telephone bill associated with the call source. The switch then establishes a telephone-based communication link to enable communication between the call source and the call-in service where the communication is charged to the telephone bill associated with the call source.

Members calling card may be implemented as part of a telecommunications system, a public switched telephone network, or as component(s) of any other communication and/or information services system, such as the Internet. While aspects of the described systems and methods for members calling card can be implemented in any of these systems, members calling card is described in the context of the following exemplary environment(s).

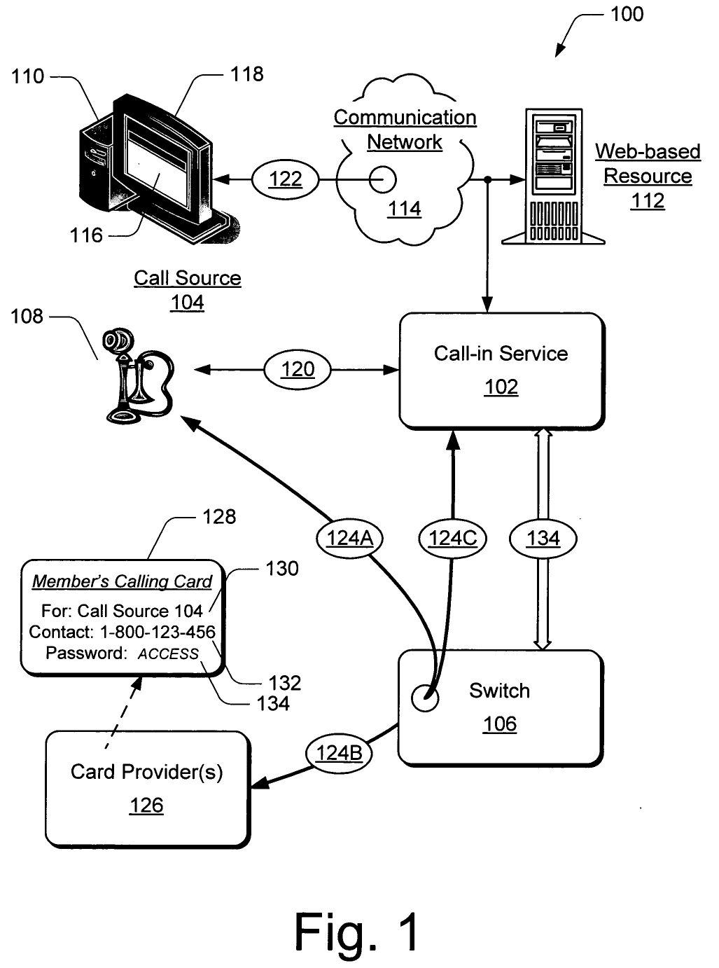

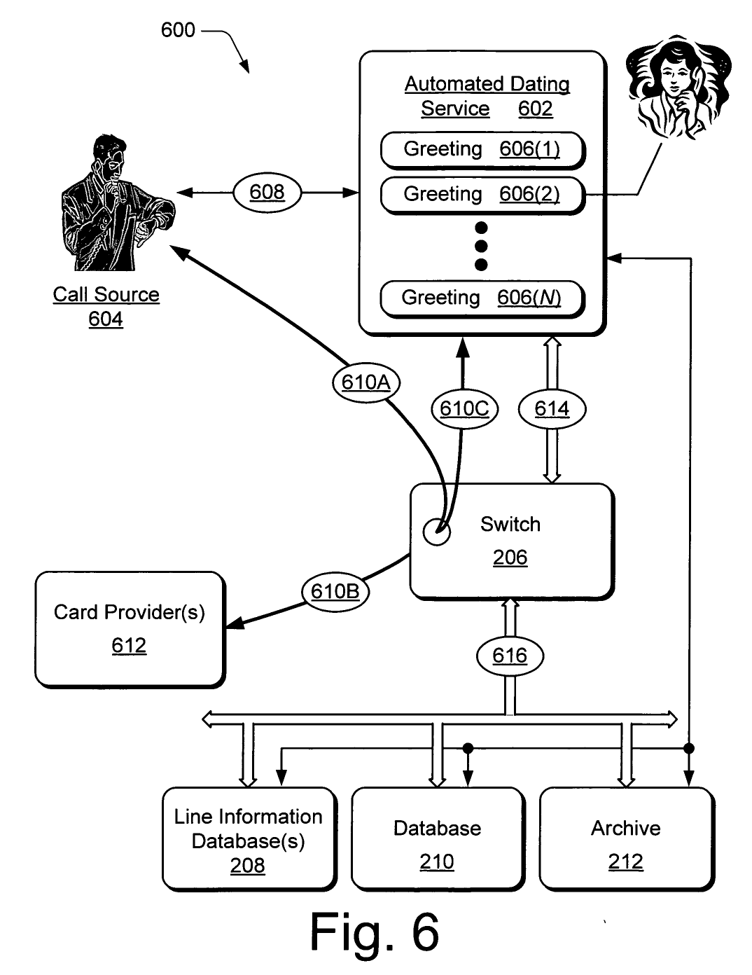

FIG. 1 illustrates an exemplary members calling card system 100 in which an embodiment of members calling card can be implemented. The members calling card system 100 includes a call-in service 102, a call source 104, and a switch 106. The system 100 can be implemented in any form of telecommunications, communications, and/or information services system to include an Internet-based communication system. Call-in service 102 may be implemented as any number of different call-in and/or automated services that provide a service for a fee, such as an information service, technical support service, research database service, and the like. In one implementation, a members calling card system can be implemented to include an automated call-in dating service which is described with reference to FIG. 6.

In the example shown in FIG. 1, call source 104 may be a person (e.g., a “caller”), a communication device 108 (e.g., a telephone, either wired or wireless), an automated device, and/or any other type of electronic or communication device at a call origin, call station, call location, etc. Optionally, call source 104 may include a computing device 110 to facilitate Web-based access to a server device, such as a Web-based resource 112 that is associated with the call-in service 102. The call-in service 102, the call source computing device 110, and the Web-based resource 112 are each configured for communication via a communication network 114, such as an intranet or the Internet. The telephone 108 can be communicatively coupled through computing device 110, or may be configured for communication independent of the computing device.

In this example, computing device 110 includes a Web browser application 116 to facilitate user interaction with the Web-based resource 112 and which can display a Web site on a display device 118 of the computing device 110. Although the Web-based resource 112, the call-in service 102, and the switch 106 are each illustrated and described as independent components of the members calling card system 100, any one or combination of the Web-based resource 112, call-in service 102, and switch 106 can be implemented as an integrated component of the system 100. Accordingly, any functionality described herein pertaining to an automated or Web-based resource, a call-in service, and/or pertaining to a switch can be performed by either one or a combination of the components as described herein with reference to the various embodiments of members calling card.

When a caller at call source 104 initiates communication with call-in service 102 via telephone 108, a communication link 120 is established such that the call-in service 102 and the call source 104 are communicatively coupled, or connected, either via a wired or wireless connection. Alternatively, when a user at call source 104 initiates a Web-based connection with the Web-based resource 112 via computing device 110, a communication link 122 is established such that the Web-based resource 112 (which is associated with the call-in service 102) and the call source 104 are communicatively coupled via the communication network 114.

A call source 104 (e.g., a telephone caller or a computer user) may be enticed to contact or initiate communication with the call-in service 102 for a duration during which the call source 104 may or may not be charged for the call (e.g., via communication link 120). The call-in service 102 can then offer the call source 104 any number of payment options to continue accessing the call-in service, such as charging the connection time to a credit card, calling a nine-hundred number to which a billing rate applies (e.g., typically on a per-minute basis), or the call-in service 102 can provide contact information via which the call source 104 can obtain a members calling card to access (or continue accessing) the call-in service 102. Optionally, the Web-based resource 112 associated with the call-in service 102 may provide the payment options to the call source 104 to access the call-in service 102, and may then provide the contact information via which the call source 104 can obtain the members calling card to access the call-in service 102. In an embodiment, the contact information is provided to the call source 104 as a toll free telephone number.

In an event that the call source 104 selects to utilize the contact information to obtain a members calling card to access the call-in service 102, the call source 104 discontinues the telephone-based communication link 120 with call-in service 102 and utilizes the contact information to call the switch 106. The switch 106 receives the communication from call source 104 and establishes a communication link 124(A-B) between the call source 104 and a card provider 126. The card provider 126 issues to the call source 104 a members calling card 128 that identifies 130 the call source and includes access information 132 to access the call-in service 102, and may include a password (or pass-number) 134. In one embodiment, the access information 132 is the same contact information (e.g., a toll free number) initially provided by the call-in service 102 to the call source 104.

The call source identifier 130 can be a unique ten-digit telephone number corresponding to the call source 104, or can be any combination of numbers and/or text designators that a call source can touch-tone, for example, to gain access to a call-in service. Similarly, the password (or pass-number) 134 can be any combination of numbers and/or text designators that a call source can touch-tone. In various embodiments of members calling card, a card provider 126 may be a telecom device, a person (e.g., an operator), and/or any other type of automated device that can respond to a request for a members calling card. Additionally, in an alternate embodiment, card provider 126 may be an integrated component of the switch 106.

The card provider 126 issues the members calling card 128 to the call source 104 when the card provider 126 receives authorization from the call source 104 that a billing rate for access to the call-in service 102 can be billed on a telephone bill associated with the call source 104. The switch 106 can notify the call-in service 102 via communication link 134 that the call source 104 is authorized to access the call-in service 102 (e.g., the call source 104 has given authorization to be billed for access to the call-in service 102).

When call source 104 is issued the members calling card 128, the switch 106 establishes a telephone-based communication link 124(A-C) to enable communication between the call source 104 and the call-in service 102. The communication can then be charged to the telephone bill associated with the call source 104 which was authorized by the call source when requesting the members calling card 128. In this example, both the communication link 124(A-B) and the telephone-based communication link 124(A-C) are routed through the switch 106.

The call-in service 102, call source 104 (to include telephone 108 and computing device 110), switch 106, Web-based resource 112, and card provider(s) 126 may each include a communication interface by which the components are communicatively linked. The communication link(s) 120, 122, 124, and 134 described with reference to FIG. 1, as well as the other communication links described herein with reference to the several embodiments and implementations of members calling card, can be implemented as any one or combination of serial, parallel, network, wireless, satellite, Internet, or public switched telephone network interface communication links that communicatively couple the components to each other and/or to other electronic or computing devices. Other examples of a communication link implementation can include digital, universal serial bus (USB), local area network (LAN), wide area network (WAN), metropolitan area network (MAN), any form of an Internet Protocol (IP) connection, and other similar types of information and communication connections.

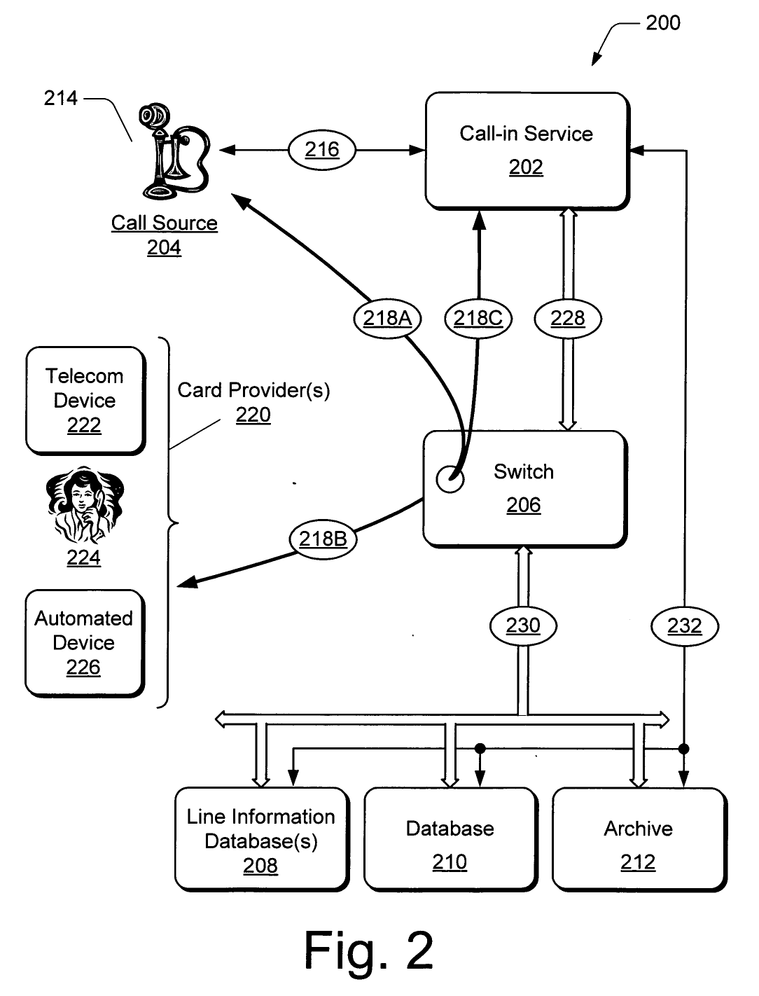

FIG. 2 illustrates an exemplary members calling card system 200 in which an embodiment of members calling card can be implemented. The calling card system 200 includes a call-in service 202, a call source 204, and a switch 206, each of which are described above with reference to similar components shown in FIG. 1. The calling card system 200 may also be implemented in any form of telecommunications, communications, and/or information services system to include an Internet-based communication system. Calling card system 200 also includes Line Information Database(s) 208, a database 210, and an archive 212.

In this example, the call source 204 may be a person (e.g., a “caller”), a communication device 214 (e.g., a telephone, either wired or wireless), an automated device, any other type of electronic or computing device, and/or any combination thereof at a call origin, call station, call location, etc. When a caller at call source 204 initiates communication with call-in service 202 via telephone 214, a communication link 216 is established such that the call-in service 202 and the call source 204 are communicatively coupled, or connected, either via a wired or wireless connection. The call-in service 202 can provide contact information (e.g., a toll free number) via which the call source 204 can obtain a members calling card to access (or continue accessing) the call-in service 202.

In an event that the call source 204 utilizes the contact information to obtain a members calling card to access the call-in service 202, the call source 204 discontinues the telephone-based communication link 216 with call-in service 202 and utilizes the contact information to call the switch 206. The switch 206 receives the communication from call source 204 and establishes a communication link 218(A-B) between the call source 204 and card provider(s) 220. A card provider 220 issues to the call source 204 a members calling card (e.g., members calling card 128 shown in FIG. 1) that includes contact information to access the call-in service 202.

As described above with reference to the members calling card 128 shown in FIG. 1, the contact information can be any one or combination of access information, a toll-free contact telephone number, and/or a password that a call source can touch-tone, for example, to gain access to a call-in service. In various embodiments of members calling card, a card provider 220 may be a telecom device 222, a person 224 (e.g., an operator), and/or any other type of automated device 226 that can respond to a request for a members calling card. Additionally, in an alternate embodiment, a card provider 220 (e.g., telecom device 222 or automated device 226) may be an integrated component of the switch 206.

The card provider 220 issues the members calling card to the call source 204 when the card provider 220 receives authorization from the call source 204 that a billing rate for access to the call-in service 202 can be billed on a telephone bill associated with the call source 204. The switch 206 can (e.g., may or may not) notify the call-in service 202 via communication link 228 that the call source 204 is authorized to access the call-in service 202 (e.g., the call source 204 has given authorization to be billed for access to the call-in service 202).

When the call source 204 is issued the members calling card, the switch 206 establishes a telephone-based communication link 218(A-C) to enable communication between the call source 204 and the call-in service 202. The communication can then be charged to the telephone bill associated with the call source 204. In this example, both the communication link 218(A-B) and the telephone-based communication link 218(A-C) are routed through the switch 206.

After the call source 204 has been issued the members calling card, and subsequently initiates access to the call-in service 202 with the contact information, the switch 206 receives the communication from the call source and establishes another telephone-based communication link (e.g., similar to communication link 218(A-C)) to enable communication between the call source 204 and the call-in service 202. The switch 206 can verify that the call source 204 is authorized to access the call-in service 202 by comparing the contact information (e.g., the toll-free number) identified with DNIS (Dialed Number Identification Service) to the originating telephone number of the call source which is identified with ANI (Automatic Number Identification). ANI is also commonly referred to as an ANIS (Automatic Number Identification Service).

If the contact information (DNIS) and the originating telephone number (ANI) correspond, or are otherwise related or are verified as associated, the switch can then establish the communication link to enable the communication between the call source 204 and the call-in service 202. Additionally, if the call source initiates communication with the switch from a telephone not associated with the contact information, the call source can provide a password from the members calling card that is associated with the contact information such that the switch can verify the billing and establish the communication link.

Switch 206 and/or call-in service 202 can query the Line Information Database(s) 208 to verify that the call source 204 can be billed for members calling card calls to access the call-in service 202 before establishing the telephone-based communication link 218(A-C) between the call source 204 and the call-in service 202. The Line Information Database 208 is also commonly referred to as “LIDB” and contains call source information, such as a service profile, name and billing address of a caller, and telephone number validation information. The line information is typically accessed by other service providers to determine how to respond to a call or call request. For example, a service provider (e.g., switch 206) can determine whether to allow call source 204 access to the call-in service 202, or to block the call and/or a call request.

The database 210 maintains a table or any other form of a data structure of relational data that can include any one or more of call-in service identifier(s), associated contact information, and associated access code(s) (e.g., passwords or pass-numbers) for a particular call-in service 202. In an event that a members calling card system is implemented with one or more switches and multiple call-in services, the switch 206 can obtain an access code for a particular call-in service so that the switch can establish a telephone-based communication link between a call source and the appropriate call-in service.

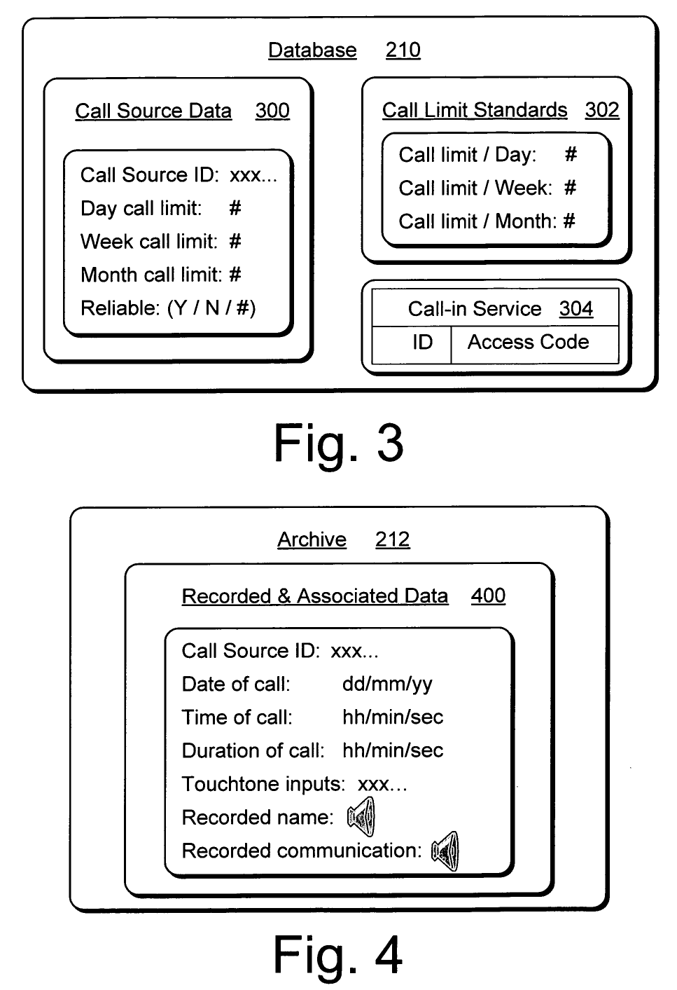

Switch 206 and/or call-in service 202 can also obtain call source data from database 210 that corresponds to the call source 204 to determine whether to authorize access to the call-in service 202. For example, the call source data can include call limits for the call source which may be compared to call limit standards, also maintained by database 210. The call limits and call limit standards are described further with reference to FIG. 3. The switch 206 and/or the call-in service 202 can be communicatively coupled to any of the Line Information Database(s) 208, database 210, and/or archive 212 via any type of communication links 230 and 232, respectively (e.g., as described with reference to the communication links shown in FIG. 1.).

The archive 212 maintains recorded data associated with the call source 204 and the communications between the call source 204 and the card provider(s) 220 and/or the call-in service 202. For example, the recorded data can include a recorded name of the call source (e.g., a caller's name verbalized by the caller for recording), a recording of a billing address of the call source, and/or a recording of a particular communication, or a portion of the communication. Before establishing either the communication link 218(A-B) or the telephone-based communication link 218(A-C), the switch 206 can communicate an instruction (e.g., via communication link 218A) to the call source 204 to verbalize a name to generate the recording of the call source name and/or to record a billing address of the call source. After establishing communication link 218(A-B) and/or the telephone-based communication link 218(A-C), the switch 206 can transfer communications, or portions thereof, to the archive 212 to maintain the recording of the communication(s). The switch 206 and/or the call-in service 202 can also verify that the recorded data has been authenticated such that the call source 204 is authorized access to the call-in service 202. For example, the recorded data, such as the recorded name and billing address of the call source, can be authenticated as factual by an independent entity or person checking that the information provided by the call source is valid.

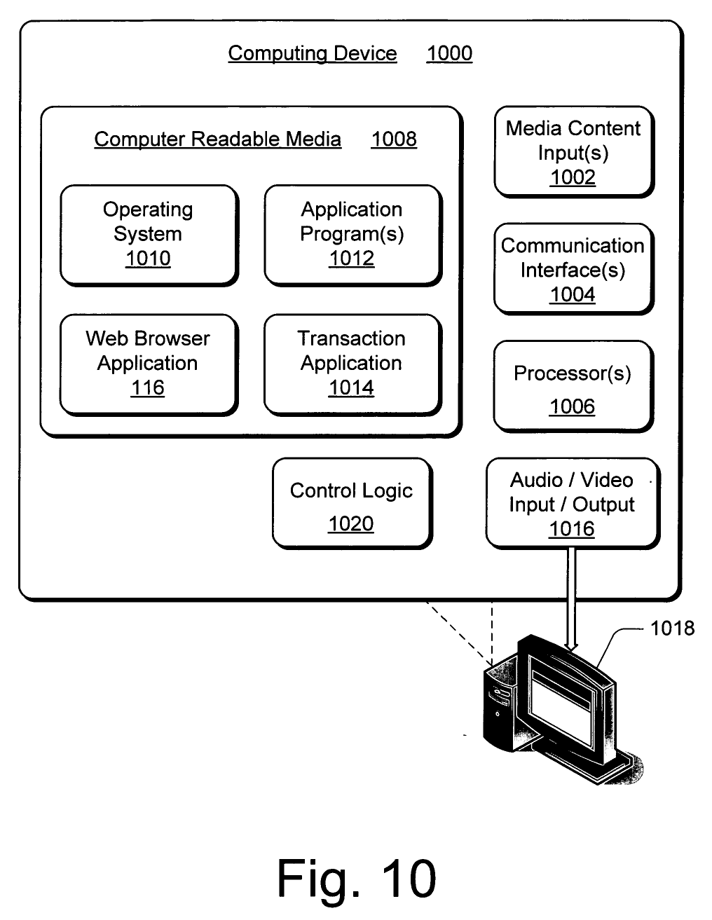

Although database 210 and archive 212 are each illustrated and described as single database implementations, each of the database 210 and the archive 212 can be implemented as several memory components distributed to each maintain data and information pertaining to the communications in any embodiment of a members calling card system as described herein. Further, although database 210 and archive 212 are each illustrated and described as separate databases, the database 210 and the archive 212 can be implemented together as a single database. Additionally, the database 210 and archive 212 can each be implemented as a memory component of the switch 206. Although not shown in this example, any of the components of a members calling card system (e.g., systems 100 and 200) may be implemented with any number and combination of differing components as further described below with reference to the exemplary computing device 1000 shown in FIG. 10.

FIG. 3 illustrates examples of data associated with members calling card and maintained with a database 210 as shown in FIG. 2. Call source data 300 corresponds to a call source (e.g., call sources 104 and 204) and can include a call source identifier (e.g., an ANI), a day call limit, a week call limit, month call limit, and/or an indication of whether the call source is reliable in paying for access charges in a timely manner. Any and/or all of the call source data 300 can be obtained by a switch 206 to determine whether to authorize access to a particular call-in service 202.

The database 210 also maintains call limit standards 302 and a table 304 (e.g., any form of a data structure) of relational data that includes a call-in service identifier and an associated access code (e.g., a password or pass-number) for a particular call-in service 202. The call limit standards 302 can be based on established thresholds as determined by uncollected revenue and/or based on the averages of all call sources (e.g., callers) that do not pay for telephone charges, such as long distance charges, collect call charges, access charges, etc. One example of call limit standards 302 can be two calls per day, one call per month, and the like.

The call limits in the call source data 300 for a particular call source 204 can be based on these call limit standards 302, or can be adjusted on a call source by call source basis. For example, the indication of whether a call source is reliable (e.g., “yes”, “no”, and/or some number or text indicator to rate a call source) can be utilized to increase or decrease a particular call source day, week, and month call limits. Optionally, a call source can be blocked from making any calls through the switch due to a poor payment history.

FIG. 4 illustrates an example of recorded and associated data 400 that is maintained in archive 212 and which corresponds to a call source communications. The recorded and associated data 400 includes any one or combination of a call source identifier associated with a communication (e.g., between the call source and a card provider and/or a call-in service), a date of the communication, a time of the communication, a duration of the communication, any call source touchtone inputs, a recorded name and/or billing address of the call source, and a recording of the communication, or a portion thereof.

The switch 206 can obtain any of this archived and recorded information corresponding to a particular communication when a call source disputes the charges for the communication. For example, when a caller (e.g., at call source 204 in FIG. 2) calls into a telephone billing company to dispute the charges for a communication to obtain a members calling card to access the call-in service 202, the caller can be communicatively linked to the recorded and associated data 400 where they will hear themselves identified (e.g., by recorded name) and at least a portion of the communication (e.g., recorded communication). Although database 210 is shown with only one example of call source data 300 for only one call source 204, and archive 212 is shown with only one example of recorded and associated data 400 for a single communication, each can maintain any number of call source data and recorded data, respectively, that corresponds to any number of call sources and associated communications.

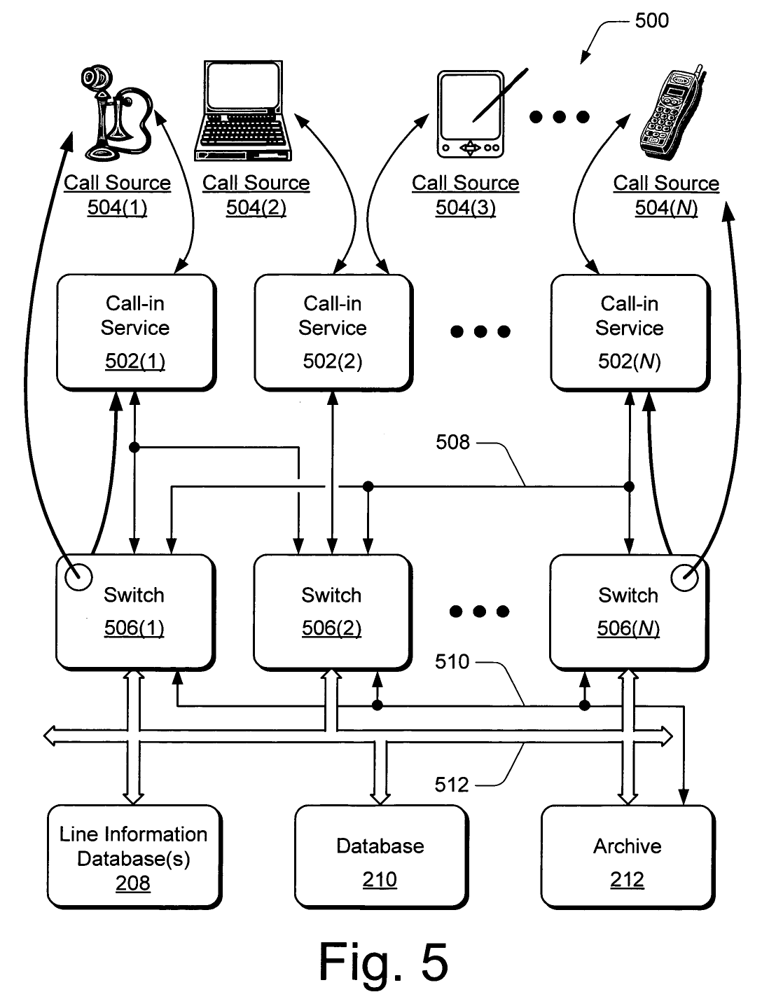

FIG. 5 illustrates an exemplary members calling card system 500 having any number of various components such as multiple call-in services 502(1-N), multiple call sources 504(1-N), and multiple switch components 506(1-N). A call source 504 can be any wired or wireless communication device such as any one or combination of a phone 504(1), a portable or desktop computer 504(2), a PDA 504(3), a cell phone 504(N), and/or any other electronic or computing device. Call source 504(2) is an example of a computing device (e.g., call source computing device 110 shown in FIG. 1) that can include a Web browser application to facilitate user interaction with a Web-based resource that is associated with a call-in service 502.

Any number of the call sources 504 can be communicatively linked to a call-in service 502 at any one time. For example, call sources 504(2) and 504(3) are each in communication with call-in service 502(2). Further, any number of the call-in services 502 can be communicatively linked to a switch component 506 at any one time via communication links 508. For example, call-in services 502(1), 502(2), and 502(N) are all in communication with switch 506(2). Additionally, each switch 506 can access the Line Information Database(s) 208, the database 210, and the archive 212 via communication links 510 and 512.

FIG. 6 illustrates an exemplary members calling card system 600 in which an embodiment of members calling card can be implemented. In this example, members calling card system 600 includes an automated dating service 602, a call source 604 (e.g., a “caller”), and the switch 206. The calling card system 600 also includes Line Information Database(s) 208, the database 210, and the archive 212 as described above with reference to FIGS. 2-4.

The automated dating service 602 includes multiple recorded greetings 606(1-N) that a caller 604 can access and listen to via a communication link 608. In this exemplary implementation, women may call into the dating service 602 free of charge and record a greeting 606. Men are enticed to call into the dating service 602 for a duration of time during which the caller 604 may or may not be charged for the call. The caller 604 can listen to the greetings 606(1-N) and select any of them to leave a return message for the person that recorded the message. Further, if a caller 604 selects a greeting that has been recorded by someone who is also connected into the service 602, the service can connect the caller and the other person, such as caller 604 and the woman that recorded greeting 606(2).

When the call source's free and/or paid access time has been expended, the dating service 602 can offer the call source 604 a number of payment options to continue accessing the service, such as charging the connection time to a credit card, calling a nine-hundred number to which a billing rate applies (e.g., typically on a per-minute basis), or the dating service 602 can provide contact information to the call source 604 via which the call source can communicate though the switch 206 to obtain a members calling card to access (or continue accessing) the dating service 602 (e.g., a call-in service).

When the caller at call source 604 utilizes the contact information to continue or to gain access to the dating service 602, the caller discontinues communication 608 with the dating service 602 and initiates communication with the switch 206. The switch 206 receives the communication from call source 604 and establishes a communication link 610(A-B) between the call source 604 and a card provider 612. A card provider 612 issues to the call source 604 a members calling card (e.g., members calling card 128 shown in FIG. 1) that authorizes the call source 604 to access or continue accessing the dating service 602.

The card provider 612 issues the members calling card to the call source 604 when the card provider 612 receives authorization from the call source 604 that a billing rate for access to the dating service 602 can be billed on a telephone bill associated with the call source 604. The switch 206 can notify the dating service 602 via communication link 614 that the call source 604 is authorized to access the dating service 602 (e.g., the caller at call source 604 has given authorization to be billed for access to the dating service 602). In various embodiments of the several members calling card systems described herein, the call source 604 may authorize being billed for access to a call-in service (e.g., the dating service 602) over the telephone, via an email, via a mail system, and/or communicate the authorization to a card provider.

When the call source 604 obtains the members calling card, the switch 206 establishes a telephone-based communication link 610(A-C) to enable communication between the call source 604 and the dating service 602. The communication can then be charged to the telephone bill associated with the call source 604. In this example, both the communication link 610(A-B) and the telephone-based communication link 610(A-C) are routed through the switch 206.

Switch 206 and/or the automated dating service 602 can query the Line Information Database(s) 208 to verify that the call source 604 can be billed for access to the dating service 602 before the telephone-based communication link 610(A-C) is established between the call source 604 and the dating service 602. The contact information received when call source 604 initiates communication with the switch 206 can include a dating service identifier (e.g., a call-in service identifier, or a toll-free number corresponding to the dating service 602) and a call source identifier (e.g., a ten-digit telephone number corresponding to the call source 604).

The switch 206 can utilize the toll-free number (e.g., contact information) and the telephone number corresponding to the call source 604 to establish the telephone-based communication link 610(A-C) between the call source 604 and the dating service 602. The switch 206 can also obtain call source data (e.g., call source data 300 shown in FIG. 3) via any type of communication link 616 from database 210 that corresponds to the call source 604 to determine whether to authorize access to the dating service 602.

Before establishing either the communication link 610(A-B) or the telephone-based communication link 610(A-C), the switch 206 can communicate an instruction (e.g., via communication link 610A) to the call source 604 to verbalize a name and/or a billing address to generate a recorded name and billing address of the call source. After establishing communication link 610(A-B) and/or the telephone-based communication link 610(A-C), the switch 206 can transfer communications, or portions thereof, to the archive 212 to maintain a recording of the communication(s).

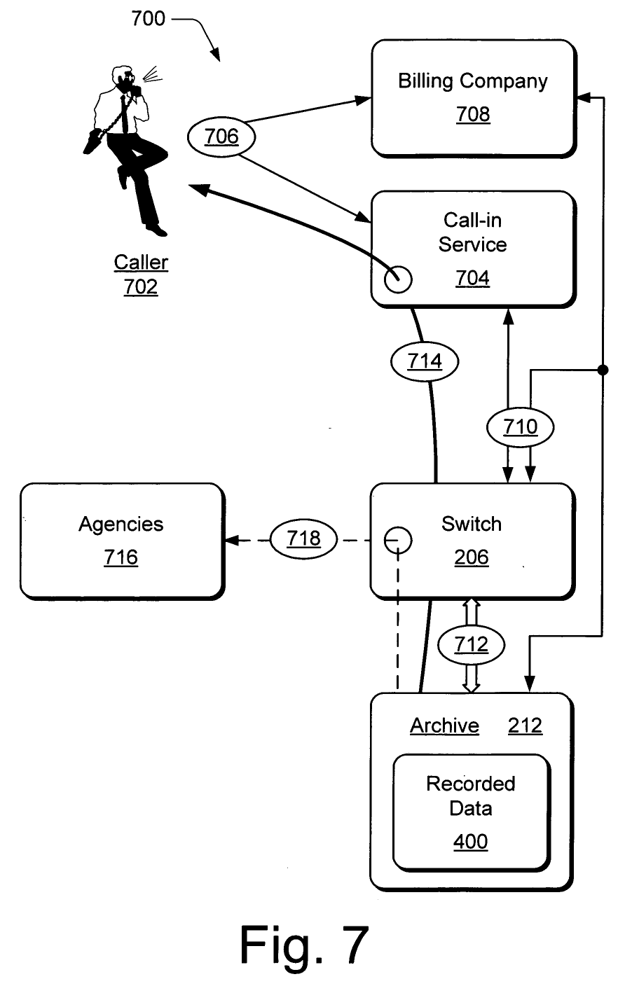

FIG. 7 further illustrates an exemplary implementation 700 of the members calling card system 600 shown in FIG. 6. In this example, a caller 702 receives a telephone bill that includes charges for communications that were authorized by the caller to access a call-in service 704 (such as the dating service 602 shown in FIG. 6, for example). The caller 702 calls 706 a billing entity to dispute the charges for an access communication, such as the telephone-based communication link 61 0(A-C) shown in FIG. 6 that is charged to the telephone bill associated with the caller 702.

The billing entity may be the switch 206, the call-in service 704, a different billing company 708, and/or any combination thereof which may include a combination of billing entities or companies that cooperate to bill the caller 702 for the access communications. The caller 702 may enter by touch tone or verbally communicate an identifier, or a combination of identifiers, to identify the disputed communication to the billing entity. For example, the caller 702 may enter by touch tone or verbally communicate a tracking number or a combination of the date and time of the access communication (e.g., identifiers or information included on or with the telephone bill).

The billing entity can then accesses the archive 212 via communication links 710 and/or 712 through the switch 206 (e.g., or the switch 206 accesses the archive 212 directly if the switch is the billing entity). For example, the billing company 708 utilizes the switch to establish a playback communication link 714 to the caller 702 and from the recorded data 400 that corresponds to the disputed communication. The caller 702 will hear his own identification (e.g., recorded name and/or billing address) and a portion of the communication (e.g., recorded communication). The recorded data can include portions of communications between the caller 702 and a card provider and/or a call-in service. The playback communication link 714 can be routed through the billing entity, such as through the call-in service 704 as shown in FIG. 7. The caller's own identification and recorded portion of the communication is more than sufficient to sustain the charges against the caller 702 for the communication.

In an alternate implementation, the switch 206 can obtain the recorded data 400 from archive 212 and submit the recorded data to another agency (or agencies) 716 via a communication link 718 through the switch 206. The recorded data can be submitted as an attached audio file to an email, for example. This may be useful for police investigations, legal challenges, and for any other similar situation to evidence that a particular caller was a party to a communication on a particular date for a recorded duration of time and/or that the caller authorized payment for the communication.

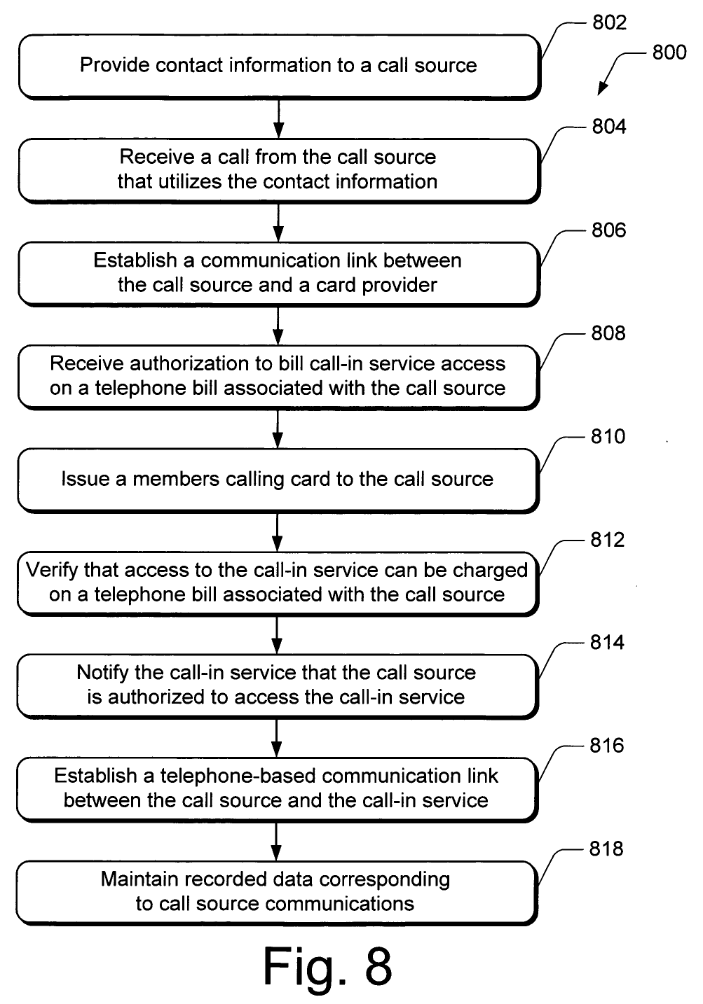

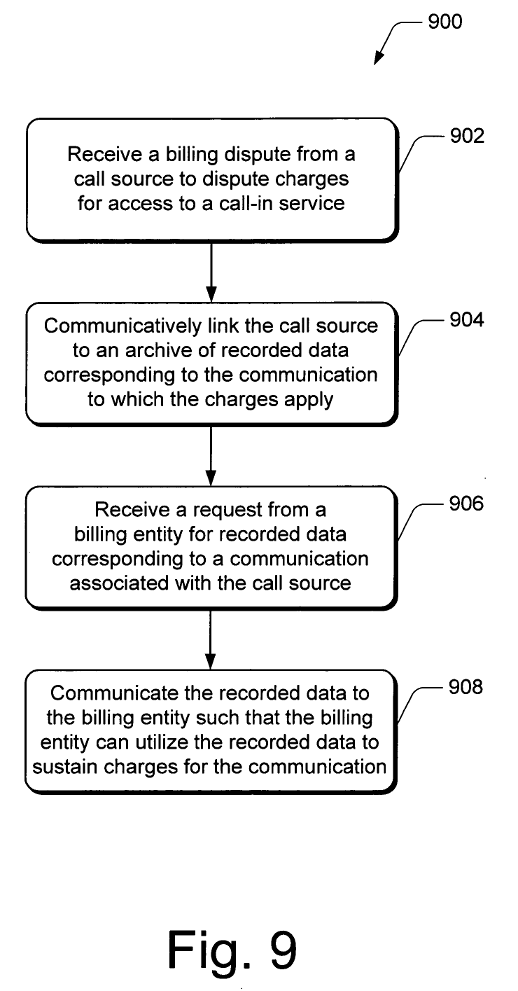

Methods for members calling card, such as exemplary methods 800 and 900 described with reference to FIGS. 8 and 9 respectively, may be described in the general context of computer executable instructions. Generally, computer executable instructions include routines, programs, objects, components, data structures, and the like that perform particular functions or implement particular abstract data types. Methods for members calling card may also be practiced in distributed computing environments where functions are performed by remote processing devices that are linked through a communications network. In a distributed computing environment, computer executable instructions may be located in both local and remote computer storage media, including memory storage devices.

FIG. 8 illustrates a method 800 for members calling card. The order in which the method is described is not intended to be construed as a limitation, and any number of the described method blocks can be combined in any order to implement the method. Furthermore, the method can be implemented in any suitable hardware, software, firmware, or combination thereof.

At block 802, contact information is provided to a call source. For example, when a call source 204 (FIG. 2) initiates communication with a call-in service 202, the call source receives the contact information from the call-in service via which the call source 204 can obtain a members calling card to access the call-in service 202. Optionally, the contact information can be provided to the call source via a Web-based resource 112 (FIG. 1) that is associated with a call-in service 102 when a call source 104 initiates communication with the Web-based resource 112.

At block 804, a call is received from a call source that utilizes the contact information received from the call-in service. For example, call source 204 (FIG. 2) initiates a call to switch 206 using the contact information received from call-in service 202. At block 806, a communication link is established between the call source and a card provider such that the call source can obtain a members calling card to access the call-in service. For example, switch 206 establishes the communication link 218(A-B) between call source 204 and a card provider 220. Optionally, the communication link 218(A-B) can be routed through the switch as shown in FIG. 2.

At block 808, authorization is received from the call source to bill access to the call-in service on a telephone bill associated with the call source. For example, the switch 206 or card provider 220 receives authorization from call source 204 to charge for the access to the call-in service 202 to a telephone bill associated with the call source 204. At block 810, a members calling card is issued to the call source. For example, the card provider issues a members calling card 128 (FIG. 1) to call source 204 when the call source authorizes that access to the call-in service 202 can be billed on a telephone bill associated with the call source 204 via the members calling card 128.

At block 812, access communication to the call-in service is verified chargeable to the telephone bill associated with the call source. For example, the switch 206 verifies that the communication between call source 204 and the call-in service 202 can be charged to the telephone bill associated with the call source 204 via the members calling card 128 issued to the call source. The verification can include the switch 206 querying the Line Information Database 208 to verify that the communication between the call source and the call-in service can be charged to the telephone bill associated with the call source. Additionally, the verification can include the switch 206 authorizing the telephone-based communication link 218(A-C) between the call source 204 and the call-in service 202 if call limits for the call source do not exceed call limit standards that identify at least one of a day limit, a week limit, or a month limit.

At block 814, the call-in service is notified that the call source is authorized to access the call-in service. For example, the switch 206 notifies the call-in service 202 via communication link 228 that the call source 204 has received the members calling card and is authorized to access the call-in service 202. At block 816, a telephone-based communication link is established to enable communication between the call source and the call-in service. For example, the switch 206 establishes the telephone-based communication link 218(A-C) to enable communication between call source 204 and the call-in service 202.

At block 818, recorded data corresponding to call source communications is maintained. For example, recorded data is maintained that includes any one or combination of a recording of a call source name, a billing address of the call source, a recording of at least a portion of a communication between the call source 204 and the card provider 220 and/or the call-in service 202, a call source identifier, a date of the communication, a time of the communication, a duration of the communication, or call source touchtone inputs. An instruction can be communicated to the call source to verbalize a name and/or a billing address to generate a recording of the call source name and/or the billing address, and the switch 206 records at least a portion of the communication between the call source 204 and the call-in service 202 and/or the card provider 220.

FIG. 9 illustrates a method 900 for members calling card. The order in which the method is described is not intended to be construed as a limitation, and any number of the described method blocks can be combined in any order to implement the method. Furthermore, the method can be implemented in any suitable hardware, software, firmware, or combination thereof.

At block 902, a billing dispute is received from a call source to dispute charges for access to a call-in service. For example, caller 702 (FIG. 7) contacts a billing entity (e.g., billing company 708, call-in service 704, and/or switch 206) to dispute charges on a telephone bill associated with the caller 702. At block 904, the call source is communicatively linked to an archive of recorded data corresponding to the communication to which the charges apply. For example, the billing entity initiates that a communication link 714 be established between caller 702 and an archive 212 of recorded data 400. The recorded data 400 can include any one or combination of a recorded name of the call source 702, a billing address of the call source 702, and a recording of at least a portion of the communication between the call source and the call-in service 704 and/or a card provider 612 (FIG. 6).

At block 906, a request is received from a billing entity for recorded data corresponding to a communication associated with the call source. For example, the switch 206 receives a request for recorded data 400 from a billing entity (e.g., billing company 708) or other agency 716 where the recorded data 400 corresponds to a communication between the caller 702 and the call-in service 704 and/or a card provider 612. The recorded data can include any one or combination of a recording of a name of the caller 702, a billing address of the call source 702, and a recording of at least a portion of the communication. At block 908, the recorded data is communicated to the billing entity such that the billing entity can utilize the recorded data to sustain charges for the communication. For example, the switch 206 obtains the recorded data 400 from archive 212 and communicates the recorded data to the billing entity or other agency 716.

FIG. 10 illustrates various components of an exemplary computing device 1000 in which embodiments of members calling card can be implemented. Further, the computing device 1000 can be implemented as any one or more of the various components of a members calling card system in which members calling card is implemented. For example, the computing device 1000 can be implemented as a call-in service (e.g., call-in services 102, 202, 502, 704, and dating service 602) a switch (e.g., switches 106, 206, and 506), a database 210 and archive 212, a Web-based resource 112, and as a call source computing device 110.

Computing device 1000 includes one or more content inputs 1002 which may include Internet Protocol (IP) inputs and/or VOIP (voice over IP) inputs over which content is received via an IP-based network. The content inputs 1002 may also include data input from user input devices that can include a keyboard, mouse, pointing device, and/or other mechanisms to interact with, and to input information to computing device 1000.

Computing device 1000 further includes communication interface(s) 1004 which can be implemented as any one or more of a serial and/or parallel interface, a wireless interface, any type of network interface, a modem, and as any other type of communication interface. A wireless interface enables computing device 1000 to receive control input commands and other information from an input device, such as from a remote control device, PDA (personal digital assistant), cellular phone, or from another infrared (IR), 802.11, Bluetooth, or similar RF input device.

A network interface provides a connection between the computing device 1000 and a communication network (e.g., communication network 114 shown in FIG. 1) by which other electronic and computing devices can communicate data with device 1000. Similarly, a serial and/or parallel interface provides for data communication directly between device 1000 and the other electronic or computing devices. A modem facilitates device 1000 communications with other electronic and computing devices via a conventional telephone line, a DSL connection, cable, and/or other type of connection.

Computing device 1000 also includes one or more processors 1006 (e.g., any of microprocessors, controllers, and the like) which process various computer executable instructions to control the operation of device 1000, to communicate with other electronic and computing devices, and to implement embodiments of members calling card. Computing device 1000 is implemented with computer readable media 1008, such as one or more memory components, examples of which include random access memory (RAM), non-volatile memory (e.g., any one or more of a read-only memory (ROM), flash memory, EPROM, EEPROM, etc.), and a disk storage device. A disk storage device can include any type of magnetic or optical storage device, such as a hard disk drive, a recordable and/or rewriteable compact disc (CD), a DVD, a DVD+RW, and the like.

Computer readable media 1008 provides data storage mechanisms to store various information and/or data such as software applications and any other types of information and data related to operational aspects of the computing device 1000. For example, an operating system 1010 and/or other application programs 1012 can be maintained as software applications with the computer readable media 1008 and executed on processor(s) 1006 to implement embodiments of members calling card. For example, the computer readable media 1008 maintains a Web browser application 116 (FIG. 1) and a members calling card application 1014 to implement various features and embodiments of members calling card. Although the members calling card application 1014 is illustrated and described as a single application configured to implement embodiments of members calling card, the members calling card application 1014 can be implemented as several component applications distributed to each perform one or more functions in a computing device in a calling card system.

The computing device 1000 also includes an audio and/or video output 1016 that provides audio and video to an audio rendering and/or display system 1018, or to other devices that process, display, and/or otherwise render audio, video, and display data. Video signals and audio signals can be communicated from computing device 1000 to a display device 1018 via an RF (radio frequency) link, S-video link, composite video link, component video link, analog audio connection, or other similar communication link.

Computing device 1000 also may include control logic 1020. As used herein, the term “logic” refers to hardware, firmware, software, or any combination thereof that may be implemented to perform the logical operations associated with a particular function or with the operability of computing device 1000, a call-in service (e.g., call-in service 202), a switch (e.g., switch 206), or a database (e.g., database 210 and archive 212). Logic may also include any supporting circuitry that is utilized to complete a given task including supportive non-logical operations. For example, logic may also include analog circuitry, memory components, input/output (I/O) circuitry, interface circuitry, power providing/regulating circuitry, and the like.

Although shown separately, some of the components of computing device 1000 may be implemented in an application specific integrated circuit (ASIC). Additionally, a system bus (not shown) typically connects the various components within computing device 1000. A system bus can be implemented as one or more of any of several types of bus structures, including a memory bus or memory controller, a peripheral bus, an accelerated graphics port, or a local bus using any of a variety of bus architectures.

Although members calling card has been described in language specific to structural features and/or methods, it is to be understood that the subject of the appended claims is not necessarily limited to the specific features or methods described. Rather, the specific features and methods are disclosed as exemplary implementations of members calling card.

1. A members calling card system, comprising:
a call-in service configured to provide contact information via which a call source can obtain a members calling card to access the call-in service; and
a card provider configured to receive a request for the members calling card from the call source that initiates use of the contact information, the card provider further configured to issue the members calling card to the call source, the members calling card issued such that communication with the call-in service is charged on a telephone bill associated with the call source.

2. A members calling card system as recited in claim 1, further comprising a switch configured to (1) receive the request from the call source that initiates use of the contact information, (2) establish a communication link between the call source and the card provider such that the call source can obtain the members calling card, and (3) establish a telephone-based communication link to enable the communication between the call source and the call-in service.

3. A members calling card system as recited in claim 2, wherein the switch is further configured to route both the communication link and route the telephone-based communication link through the switch.

4. A members calling card system as recited in claim 2, wherein the switch is further configured to verify that the telephone-based communication link between the call source and the call-in service can be charged on the telephone bill associated with the call source.

5. A members calling card system as recited in claim 2, wherein the switch is further configured to notify the call-in service that the call source is authorized to access the call-in service.

6. A members calling card system as recited in claim 2, wherein the switch is further configured to query a Line Information Database to verify that the telephone-based communication link between the call source and the call-in service can be charged on the telephone bill associated with the call source.

7. A members calling card system as recited in claim 2, wherein the switch is further configured to:
receive a request from a billing entity for recorded data corresponding to a communication between the call source and the call-in service, the recorded data including at least one of a recording of a name of the call source or a recording of at least a portion of the communication; and
communicate the recorded data to the billing entity such that the billing entity can utilize the recorded data to sustain charges for the communication.

8. A members calling card system as recited in claim 2, wherein the switch is further configured to:
receive a request from a billing entity for recorded data corresponding to a communication between the call source and the card provider, the recorded data including at least one of a recording of a name of the call source, a billing address of the call source, or a recording of at least a portion of the communication between the call source and the card provider; and
communicate the recorded data to the billing entity such that the billing entity can utilize the recorded data to sustain charges for the communication.

9. A members calling card system as recited in claim 2, wherein the call-in service is implemented as a component of the switch.

10. A members calling card system as recited in claim 2, wherein the call-in service and the card provider are each implemented as components of the switch.

11. A members calling card system as recited in claim 2, further comprising a database configured to maintain call source data associated with the call source, and wherein the switch is further configured to obtain the call source data from the database and authorize the telephone-based communication link between the call source and the call-in service.

12. A members calling card system as recited in claim 2, further comprising a database configured to maintain call limit data corresponding to the call source, and wherein the switch is further configured to obtain the call limit data from the database and authorize the telephone-based communication link between the call source and the call-in service.

13. A members calling card system as recited in claim 2, further comprising a database configured to maintain recorded data corresponding to the call source, the recorded data including at least one of a recording of a name of the call source, a billing address of the call source, or a recording of at least a portion of the communication between the call source and the card provider, and wherein the switch is further configured to verify that the recorded data has been authenticated such that the call source is authorized access to the call-in service.

14. A members calling card system as recited in claim 2, further comprising a database configured to maintain an archive of recorded data associated with a communication between the call source and the card provider, the recorded data including at least one of a recorded name of the call source, a billing address of the call source, or a recording of at least a portion of the communication between the call source and the card provider, and wherein the switch is further configured to communicate an instruction to the call source to verbalize a name to generate the recorded name of the call source and transfer at least a portion of the communication to the database to generate the recording of the communication.

15. A members calling card system as recited in claim 14, wherein the archive of recorded data further includes at least one of a call source identifier, a date of the communication, a time of the communication, a duration of the communication, or call source touchtone inputs.

16. A members calling card system as recited in claim 2, further comprising a database configured to maintain an archive of recorded data associated with the communication between the call source and the call-in service, the recorded data including a recorded name of the call source and a recording of at least a portion of the communication between the call source and the call-in service, and wherein the switch is further configured to communicate an instruction to the call source to verbalize a name to generate the recorded name of the call source and transfer at least a portion of the communication to the database to generate the recording of the communication.

17. A members calling card system as recited in claim 16, wherein the archive of recorded data further includes at least one of a call source identifier, a date of the communication, a time of the communication, a duration of the communication, or call source touchtone inputs.

18. A members calling card system as recited in claim 2, further comprising a billing entity configured to receive a billing dispute from the call source to dispute charges for access to the call-in service, and wherein the switch is further configured to communicatively link the call source to an archive of recorded data corresponding to a communication to which the charges apply, the recorded data including at least one of a recording of a name of the call source or a recording of at least a portion of the communication between the call source and the call-in service.

19. A members calling card system as recited in claim 2, further comprising a billing entity configured to receive a billing dispute from the call source to dispute charges for access to the call-in service, and wherein the switch is further configured to communicatively link the call source to an archive of recorded data corresponding to a communication to which the charges apply, the recorded data including at least one of a recording of a name of the call source, a billing address of the call source, or a recording of at least a portion of the communication between the call source and the card provider.

20. A members calling card system as recited in claim 1, further comprising a Web-based resource associated with the call-in service and configured to provide the contact information to the call source.

21. A members calling card system as recited in claim 1, wherein the card provider is further configured to receive authorization from the call source to bill the access to the call-in service on the telephone bill associated with the call source.

22. A members calling card system as recited in claim 1, wherein the card provider is further configured to issue the members calling card to the call source when the call source authorizes that a billing rate for access to the call-in service can be billed on the telephone bill associated with the call source.

23. A telecommunications system comprising the members calling card system as recited in claim 1.

24. A members calling card system, comprising:
a billing entity configured to receive a billing dispute from a caller to dispute charges for access to a call-in service, the charges having been authorized by the caller to obtain a members calling card configured such that communication with the call-in service is charged on a telephone bill associated with the caller; and
a switch configured to communicatively link the caller to an archive of recorded data corresponding to a communication between the caller and the call-in service, and to which the charges apply, the recorded data including at least one of a recording of at least a portion of the communication between the caller and the call-in service, a billing address of the caller, or a recorded name of the caller verbalized by the caller.

25. A members calling card system as recited in claim 24, wherein the call-in service is implemented as a component of the switch.

26. A members calling card system as recited in claim 24, wherein the billing entity is implemented as a component of the switch.

27. A members calling card system as recited in claim 24, further comprising a card provider configured to issue the members calling card to the caller when the caller authorized having the charges billed on the telephone bill associated with the caller.

28. A members calling card system as recited in claim 24, wherein the archive of recorded data further includes at least one of a call source identifier, a date of the communication, a time of the communication, a duration of the communication, or call source touchtone inputs.

29. A members calling card system as recited in claim 24, wherein the switch is further configured to communicate the recorded data to the billing entity such that the billing entity can utilize the recorded data to sustain charges for the communication.

30. A method, comprising:
receiving a call from a call source that utilizes contact information received from a call-in service;
establishing a communication link between the call source and a card provider such that the call source can obtain a members calling card to access the call-in service where the access is charged on a telephone bill associated with the call source; and
establishing a telephone-based communication link to enable communication between the call source and the call-in service where the communication is charged on the telephone bill associated with the call source.

31. A method as recited in claim 30, further comprising routing both the communication link and the telephone-based communication link through a switch that receives the call from the call source, establishes the communication link between the call source and the card provider, and that establishes the telephone-based communication link between the call source and the call-in service.

32. A method as recited in claim 30, further comprising providing the contact information to the call source when the call source initiates communication with the call-in service.

33. A method as recited in claim 30, further comprising providing the contact information to the call source via a Web-based resource associated with the call-in service when the call source initiates communication with the Web-based resource.

34. A method as recited in claim 30, further comprising issuing the members calling card to the call source, the members calling card including the contact information for subsequent access to the call-in service and a password.

35. A method as recited in claim 30, further comprising notifying the call-in service that the call source is authorized to access the call-in service.

36. A method as recited in claim 30, further comprising receiving authorization from the call source to bill access to the call-in service on the telephone bill associated with the call source.

37. A method as recited in claim 30, further comprising receiving a second call from the call source that utilizes the members calling card to subsequently access the call-in service, and establishing a second communication link between the call source and the call-in service where the subsequent access is charged on the telephone bill associated with the call source.

38. A method as recited in claim 30, further comprising providing the members calling card to the call source when the call source authorizes that a billing rate for access to the call-in service can be billed on the telephone bill associated with the call source.

39. A method as recited in claim 30, further comprising:
communicating an instruction to the call source to verbalize a name and a billing address;
recording the name of the call source and the billing address of the call source; and
recording at least a portion of a communication between the call source and the card provider.

40. A method as recited in claim 30, further comprising:
communicating an instruction to the call source to verbalize a name;
recording the name of the call source; and
recording at least a portion of the communication between the call source and the call-in service.

41. A method as recited in claim 30, further comprising maintaining recorded data that includes at least one of a recording of a call source name, a recording of a billing address of the call source, a recording of at least a portion of a communication between the call source and the card provider, a call source identifier, a date of the communication, a time of the communication, a duration of the communication, or call source touchtone inputs.

42. A method as recited in claim 30, further comprising maintaining recorded data that includes at least one of a recording of a call source name, a recording of at least a portion of the communication between the call source and the call-in service, a call source identifier, a date of the communication, a time of the communication, a duration of the communication, or call source touchtone inputs.

43. A method as recited in claim 30, further comprising verifying that the communication between the call source and the call-in service can be charged to the telephone bill associated with the call source.

44. A method as recited in claim 30, further comprising querying a Line Information Database to verify that the communication between the call source and the call-in service can be charged to the telephone bill associated with the call source.

45. A method as recited in claim 30, further comprising:
maintaining call limits for the call source;
obtaining the call limits for the call source; and
authorizing the telephone-based communication link between the call source and the call-in service if the call limits for the call source do not exceed call limit standards that identify at least one of a day limit, a week limit, or a month limit.

46. A method as recited in claim 30, further comprising receiving a billing dispute from the call source to dispute charges for access to the call-in service, and communicatively linking the call source to an archive of recorded data corresponding to the communication to which the charges apply.

47. A method as recited in claim 30, further comprising:
receiving a billing dispute from the call source to dispute charges for access to the call-in service; and
communicatively linking the call source to an archive of recorded data corresponding to the communication to which the charges apply, the recorded data including a recording of a name of the call source and a recording of at least a portion of the communication between the call source and the call-in service.

48. A method as recited in claim 30, further comprising:
receiving a billing dispute from the call source to dispute charges for access to the call-in service; and
communicatively linking the call source to an archive of recorded data corresponding to the communication to which the charges apply, the recorded data including a recording of a name of the call source, a recording of a billing address of the call source, and a recording of at least a portion of a communication between the call source and the card provider.

49. A method as recited in claim 30, further comprising receiving a request from a billing entity for recorded data corresponding to the communication between the call source and the call-in service, and communicating the recorded data to the billing entity such that the billing entity can utilize the recorded data to sustain charges for the communication.

50. A method as recited in claim 30, further comprising:
receiving a request from a billing entity for recorded data corresponding to the communication between the call source and the call-in service, the recorded data including a recording of a name of the call source and a recording of at least a portion of the communication; and
communicating the recorded data to the billing entity such that the billing entity can utilize the recorded data to sustain charges for the communication.

51. A method as recited in claim 30, further comprising:
receiving a request from a billing entity for recorded data corresponding to a communication between the call source and the card provider, the recorded data including a recording of a name of the call source, a recording of a billing address of the call source, and a recording of at least a portion of the communication; and
communicating the recorded data to the billing entity such that the billing entity can utilize the recorded data to sustain charges for the communication.

52. One or more computer-readable media comprising computer executable instructions that, when executed, direct a telecommunications switch to:
receive a call from a call source that utilizes contact information received from a call-in service;
establish a communication link between the call source and a card provider such that the call source can obtain a members calling card to access the call-in service where the access is charged on a telephone bill associated with the call source; and
establish a telephone-based communication link to enable communication between the call source and the call-in service where the communication is charged on the telephone bill associated with the call source.

53. One or more computer-readable media as recited in claim 52, further comprising computer executable instructions that, when executed, direct the telecommunications switch to route both the communication link and the telephone-based communication link through the telecommunications switch.

54. One or more computer-readable media as recited in claim 52, further comprising computer executable instructions that, when executed, direct the telecommunications switch to notify the call-in service that the call source is authorized to access the call-in service.

55. One or more computer-readable media as recited in claim 52, further comprising computer executable instructions that, when executed, direct the telecommunications switch to:
receive a second call from the call source that utilizes the members calling card to subsequently access the call-in service; and
establish a second telephone-based communication link between the call source and the call-in service where the subsequent access is charged on the telephone bill associated with the call source.

56. One or more computer-readable media as recited in claim 52, further comprising computer executable instructions that, when executed, direct the telecommunications switch to record a name of the call source, a billing address of the call source, and record at least a portion of a communication between the call source and the card provider.

57. One or more computer-readable media as recited in claim 52, further comprising computer executable instructions that, when executed, direct the telecommunications switch to record a name of the call source, and record at least a portion of the communication between the call source and the call-in service.

58. One or more computer-readable media as recited in claim 52, further comprising computer executable instructions that, when executed, direct the telecommunications switch to verify that the communication between the call source and the call-in service can be charged to the telephone bill associated with the call source.

59. One or more computer-readable media as recited in claim 52, further comprising computer executable instructions that, when executed, direct the telecommunications switch to query a Line Information Database to verify that the communication between the call source and the call-in service can be charged to the telephone bill associated with the call source.
